(19) United States
(12) Patent Application Publication
(10) Pub. No.: US 2009/0120933 A1
(43) Pub. Date: May 14, 2009

(54) TECHNIQUES FOR MANUFACTURING MOLDED COMPONENTS FOR USE WITH GAMING SYSTEMS

(75) Inventors: Scott Clear, Escondido, CA (US); Kehl Lesourd, Reno, NV (US)

Correspondence Address: Weaver Austin Villeneuve & Sampson LLP - IGT;Attn: IGT, P.O. Box 70250, Oakland, CA, 94612-0250, US

(73) Assignee: IGT, Reno, NV (US)

(21) Appl. No.: 12/258,673

(22) Filed: Oct. 27, 2008

Related U.S. Application Data
(60) Provisional application No. 61/002,607, filed on Nov. 9, 2007.

(51) Int. Cl. B65D 51/12; B29C 43/00

(52) U.S. Cl. 220/213; 264/325

(57) ABSTRACT

A method is provided for manufacturing a conical-shaped cover device from a transparent, thermally deformable sheet material. The method includes supporting the sheet material about a peripheral base portion of the conical-shaped cover device to be formed. The base portion substantially encloses an interior region thereof. This region is heated to a deformable condition that enables deformability thereof. At least one of a central portion of the interior region and the base portion of the conical shaped device is urged in a direction opposite one another, generally along the longitudinal axis of the conical-shaped cover device. A non-contacted conical intermediate portion of the conical shaped cover, between the central portion and the base portion, is formed in a manner that substantially preserves the optical and/or surface finish properties of the sheet material without the need for secondary processing thereof.

### CROSS-REFERENCE TO RELATED APPLICATIONS

This application claims priority under 35 U.S.C. 119(e) from co-pending U.S. Provisional Patent Application No. 60/002,607, filed Nov. 9, 2007, titled “TECHNIQUES FOR MANUFACTURING MOLDED COMPONENTS FOR USE WITH GAMING SYSTEMS,” naming Lesourd et al. as inventors, and which is incorporated herein by reference for all purposes.

### TECHNICAL FIELD

This invention relates to gaming machines such as slot machines and video poker machines. More particularly, the present invention relates to techniques for manufacturing molded components or parts for use with gaming systems.

### BACKGROUND ART

Many of today's gaming casinos feature numerous different multi-player gaming systems such as, for example, the well known Wheel of Fortune® Super Spin™ Video Slots gaming system (manufactured by IGT, Reno, Nev.), which comprises nine video slot player stations positioned in a circular formation around a giant Super Spin™ bonus wheel.

A significant concern for casino operators relates to patron access to the bonus wheel device. For example, to ensure patron safety and prevent bonus play cheating, it may be preferable that the access to the bonus wheel be restricted or limited only to authorized personnel.

One common technique used to restrict access to the bonus wheel device is via the use of a clear dome-shaped cover which covers the visible portions of the bonus wheel device. The complexities of the dome manufacturing process, however, have traditionally required significant amounts of time, money, and labor in order to produce a dome having acceptable size, shape, and optical characteristics.

For example a dome suitable for covering the Wheel of Fortune® Super Spin™ bonus wheel device would need to be about 13 feet in diameter. Additionally, it is desirable for the dome to be as transparent and unobtrusive as possible.

Typically, such domes are manufactured using a flat sheet of acrylic which has been formed (e.g., during a manufacturing/molding process) into a semi spherical dome shape. However, since most acrylic dome of manufacturers do not have the capability of manufacturing a 13 foot semi spherical dome, such a dome is typically manufactured into three separate pieces, which are joined together at the seams to collectively form a 13 foot semi spherical dome. These seams, which result from the joining of the dome pieces, are visible and generally undesirable.

In addition to the issues relating to the size limitations of the bonus wheel device cover, there are also issues relating to the significant amounts of labor and time required to manufacture the dome.

For example, during the conventional manufacturing process of each dome piece, an acrylic sheet of plastic is heated to a desired temperature, and then compression molded on both sides by male and female compression tools to mold the plastic into a portion or piece of the semi-spherical shape. As a result of the compression molding process, significant portions of the inner and outer surfaces of the formed dome become scored, scratched, and pitted with marks, creating an appearance resembling the inner surface of an orange peel (and often referred to as the “orange peel” effect). After the plastic sheet has been formed into a dome shape, a significant amount of “secondary processing” is required to be performed on the dome in order to buff out the scratches/marks on the surfaces of the dome, and to polish the dome surfaces in order to achieve a substantially transparent and optically clear surface with no visible imperfections. Such secondary processing adds cost to the final product, as well as increases the scrap rate due to product failing to pass quality control.

Accordingly, it is desirable to implement new designs and shapes of bonus wheel device covers which may be manufactured using different molding/manufacturing processes that do not cause or create the “orange peel” effect markings/scratches associated with conventional compression molding processes, and which significantly reduce, if not eliminate, “secondary processing” to be performed on the cover, as required by the above-described conventional dome manufacturing process.

### DISCLOSURE OF INVENTION

The present invention provides a method for manufacturing a conical-shaped cover device from a substantially planar, substantially transparent, thermally deformable sheet material including substantially supporting the sheet material about a peripheral base portion of the conical-shaped cover device to be formed. The transparent sheet material has a first set of optical and surface finish properties commensurate with a smooth surfaced, highly transparent material. The base portion substantially encloses an interior region thereof. The interior region is then heated to a deformable condition that enables deformability of this region. The method further includes urging at least one of a central portion of the interior region and the base portion of the conical shaped device in a direction opposite one another, generally along the longitudinal axis of the conical-shaped cover device. As the contacted central portion and the contacted base portion are relatively urged in directions opposite one another, a non-contacted, conical intermediate portion of the conical shaped cover, between the central portion and the base portion, is formed in a manner that substantially preserves the first set of optical and/or surface finish properties.

Accordingly, a conical-shaped cover device for a large spinning bonus wheel of a gaming machine, such as a “Wheel of Fortune® Super Spin™ Video Slots gaming system” is formed through a novel manufacturing technique that eliminates the need for secondary surface refinishing since the original optical and surface finish properties of the transparent sheet material are substantially preserved. Unlike the conventional dome-shaped cover devices currently employed, this fabrication technique does not require any contact with the conical region between the central portion and the base portion during fabrication.

In one specific embodiment of the present invention, the supporting the sheet material includes substantially preventing displacement of the base portion in a direction along a longitudinal axis of the conical-shaped cover device.

In another specific embodiment of the present invention, the supporting the sheet material includes clamping the base portion of the conical-shaped cover device between an upper surface of the sheet material and an opposed lower surface of the sheet material.

In still another configuration of the present invention, the clamping is performed by clamping members contacting the upper surface and the opposed lower surface the sheet material.

In yet another specific embodiment, each clamping member is ring-shaped.

In another configuration, the urging of at least one of a central portion of the interior region and the base portion includes contacting the interior region central portion with a plunger head pushing the central portion in the direction along the longitudinal axis and away from the base portion.

In yet another specific embodiment, the base portion of the conical-shaped cover device is substantially circular, as is the plunger head, having a diameter substantially smaller than that of the base portion.

In another aspect of the present invention, a conical-shaped cover device is provided that is manufactured by the process above indicated.

### BRIEF DESCRIPTION OF THE DRAWING

The assembly of the present invention has other objects and features of advantage which will be more readily apparent from the following description of the best mode of carrying out the invention and the appended claims, when taken in conjunction with the accompanying drawing, in which:

FIG. 1 is a top perspective view of a cone-shaped cover device manufactured using the method in accordance with the present invention.

FIG. 2A is top perspective view of a thermally deformable sheet material supported between a pair of ring-shaped clamp members designed in accordance with one specific embodiment of the present invention.

FIG. 2B is top perspective view of the sheet material of FIG. 2A, having a plunger device pushing upwardly in a direction along a longitudinal axis of the conical-shaped cover device formed thereby.

FIG. 2C is top perspective view of an alternative embodiment to the formation of the conical-shaped cover device of FIG. 2B, having the plunger device pushing downwardly in a direction along the longitudinal axis of the conical-shaped cover device formed thereby.

FIG. 2D is a top perspective view of the cone-shaped cover device manufactured using the methods shown in FIGS. 2A-2C.

FIG. 3 is a top plan view of a sectional alternative embodiment of the conical-shaped cover device of FIG. 1.

FIG. 4 is a side elevation view, in cross-section, taken along the plane of the line A-A in FIG. 3.

FIG. 5 is an enlarged, fragmentary, side elevation view of a base portion of the conical-shaped cover device of FIG. 4.

FIGS. 6A-6C are various top perspective views of one embodiment of a multi-player, Wheel of Fortune® Super Spin™ Video Slots gaming system that incorporates the sectional conical-shaped cover device of FIG. 3, manufactured using the method in accordance with the present invention.

FIG. 7 is a top perspective view of another embodiment of a multi-player, Wheel of Fortune® Super Spin™ Video Slots gaming system that incorporates the conical-shaped cover device of FIG. 1, manufactured using the method in accordance with the present invention.

### BEST MODE OF CARRYING OUT THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not obscure the present invention.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

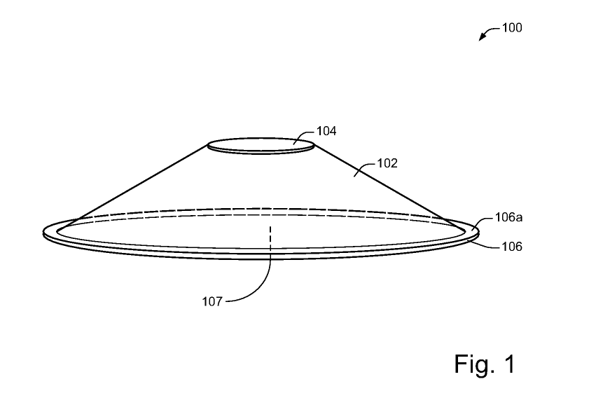

At least one aspect described herein relates to improved techniques for manufacturing molded components or parts for use with gaming systems. Referring now to FIG. 1, an example of a specific embodiment of a conical-shaped bonus wheel device cover device 100 is illustrated that may be manufactured using one or more manufacturing techniques described herein.

As illustrated in the example of FIG. 1, the conical-shaped cover device 100 may have a substantially conical shell-type shape, and may include (e.g., relative to the orientation of FIG. 1) a central portion 104, a base portion 106, and an intermediate portion 102 between central portion 104 and base portion 106. The intermediate portion 102 tapers inwardly from base portion 106 to central portion 104.

In at least one embodiment, central portion 104 may have a substantially flat or planar surface. In other embodiments, central portion 104 may have a curved surface.

In at least one embodiment, base portion 106 may include a flange portion (e.g., 106a). In one embodiment, flange portion 106a may be substantially flat or planar, is preferably an annular ring, or portion thereof.

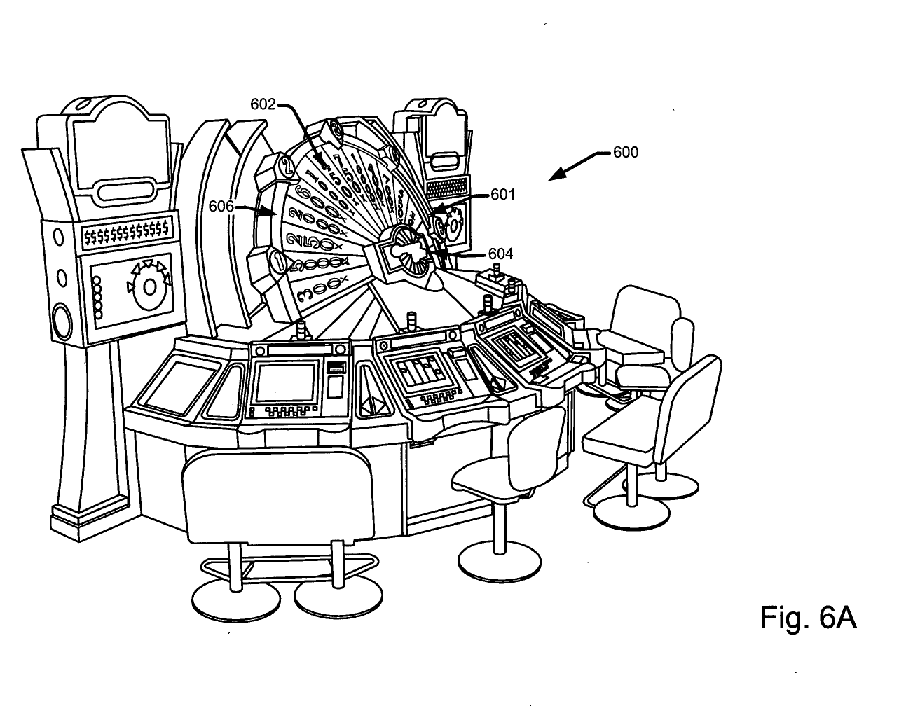

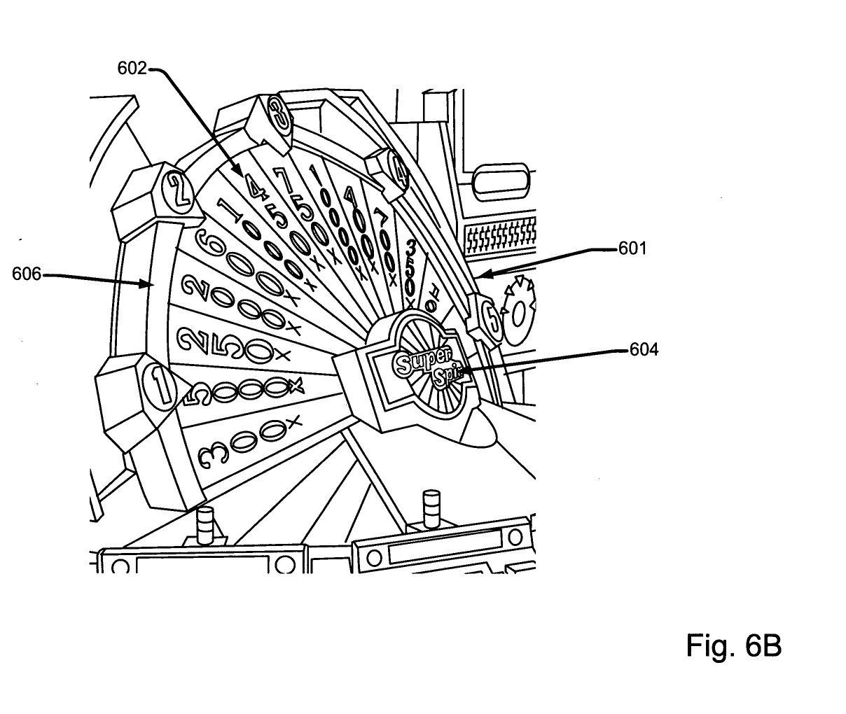

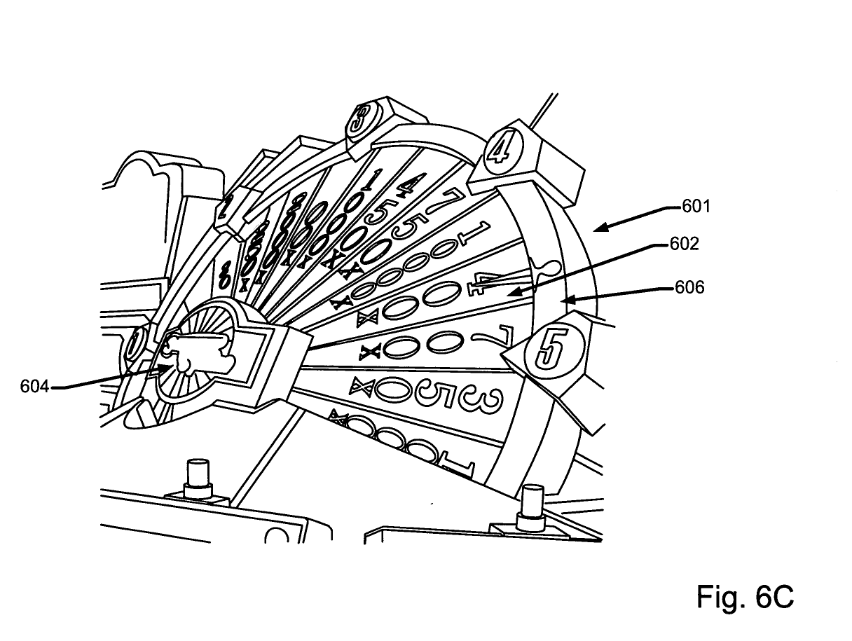

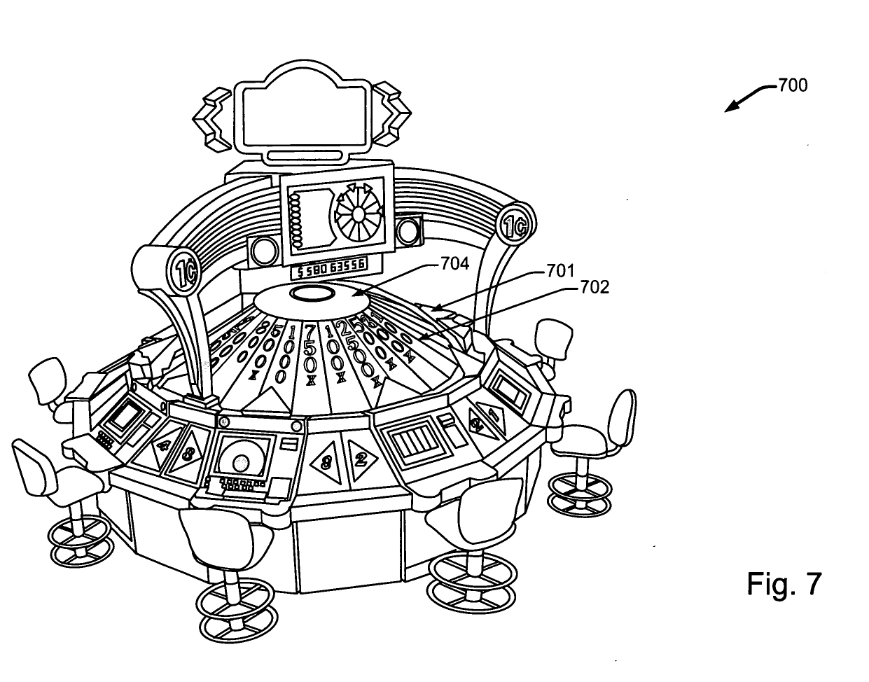

The conical-shaped intermediate portion 102 of the cover device, located between central portion 104 and base portion 106, forms a substantially conical shape surrounding inner cavity 107. As shown in FIGS. 6-7, this cavity is configured for receipt of the spinning bonus wheel therein of the gaming system.

According to different embodiments, cover device 100 may be formed using a variety of different types of material such as, for example, one or more thermally deformable materials, such as:

ABS Plastic

Acrylic

Polycarbonate

Glass

Thermoformed Plastics

Other types of thermally deformable materials may be applied, of course, which can be formed into desired shapes, and which have appropriate optical properties and/or surface finish properties.

In at least one embodiment, it is desired that intermediate portion 102 have optical properties (e.g., haze, visible transmission, etc.) and/or surface finish (e.g., surface roughness or surface smoothness) properties which meet or exceed minimum specified criteria. In at least one embodiment, the minimum specified criteria may be based on the type of material(s) being used. For instance, in at least one embodiment, it may be preferable that intermediate portion 102 of cover device 100 have an optical haze property which is less than or equal to 3%, and/or have an optical visible transmission property which is equal to or greater than 90%.

In another configuration, it may be preferable that intermediate portion 102 have a set of high quality optical properties (e.g., less than or equal to about 3% haze and greater than or equal to about 90% visible transmission properties???) which are at least equal to or better than the optical properties of the sheet material (e.g., acrylic sheet) which is used to form the cover. Thus, for example, if the cover is to be formed using a sheet of acrylic material having optical properties (before shape processing) of 3% haze and 90% visible transmission, it is preferable that, after shape processing, intermediate portion 102 of the shaped acrylic also have optical properties which meet or exceed 3% haze and 90% visible transmission.

In one specific application, it may be preferable that intermediate portion 102 (and/or other portions of the shaped item) have high quality surface finish properties (e.g., surface roughness greater than or equal to about 2000 grit, etc.) which substantially matches the surface finish properties of the material (e.g., acrylic sheet) used to form the cover before shape processing. Thus, for example, if the cover is to be formed using a sheet of acrylic material having a surface finish of about 2000 grit (before shape processing), it may be preferable that, after shape processing, intermediate portion 102 of the shaped acrylic also has a surface finish which is equal to or greater than 2000 grit.

In at least one embodiment, properties relating to surface finish or surface roughness may include, for example, one or more of the following (or combinations thereof):
Roughness—Roughness relates to surface irregularities which result from the various machining process. These irregularities combine to form surface texture.
Roughness Height—The height of the irregularities with respect to a reference line. It may be measured in millimeters or microns or microinches. It is also known as the height of unevenness.
Roughness Width—The roughness width is the distance parallel to the nominal surface between successive peaks or ridges which constitute the predominate pattern of the roughness. It may be measured in millimeters.
Roughness Width Cut Off—Roughness width cut off is the greatest spacing of respective surface irregularities to be included in the measurement of the average roughness height.
Lay—Lay represents the direction of predominant surface pattern produced and it reflects the machining operation used to produce it.
Waviness—This refers to the irregularities which are outside the roughness width cut off values. Waviness is the widely spaced component of the surface texture.
Waviness Width—Waviness height is the peak to valley distance of the surface profile, measured in millimeters, for example.

As described herein, at least one novel and inventive shape forming process described herein may be utilized to perform shape manipulation of a desired material in a manner which preserves the optical and/or surface finish properties of the material during the shape formation processing. For example, as described in greater detail below, one embodiment of a manufacturing process described herein may be used to transform a flat sheet of clear acrylic material (and/or other types of shapeable materials) into the shaped cover illustrated in FIG. 1, wherein the optical properties and/or surface finish properties of intermediate portion 102 of the shaped cover are substantially similar or substantially identical to the optical properties and/or surface finish properties of the acrylic sheet before shape processing.

Thus, for example, cover device 100 may be manufactured using at least one molding/manufacturing process which does not result in intermediate portion 102 having “orange peel” effect type markings/scratches associated with conventional compression molding processes. As a result, the cover device 100 may be formed in a manner which results in intermediate portion 102 of the formed cover having a substantially transparent surface with no visible imperfections, and without requiring “secondary processing” to be performed on intermediate portion 102 of the cover.

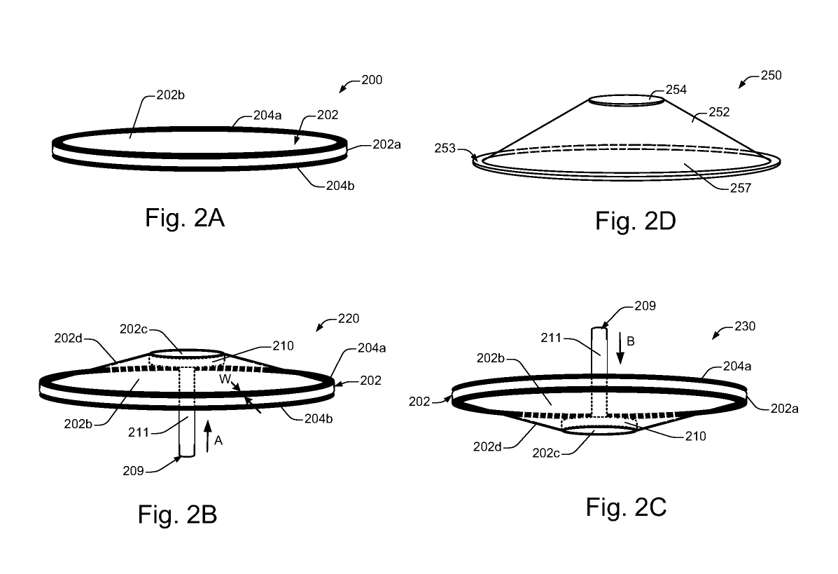

FIGS. 2A-2D illustrate examples of different manufacturing processes which may be used to perform shape manipulation of a desired material in a manner which preserves the optical and/or surface finish properties of desired portions of the material during the manufacturing process.

In accordance with one embodiment of the present invention, it is desired to form a bonus wheel device cover (e.g., similar to cover device 100 of FIG. 1) from a singular flat sheet of transparent, thermally deformable material. In one particular configuration, the sheet material is composed of a clear, flat sheet of acrylic material. It will be appreciated, however, that in alternate embodiment thermally deformable materials other than acrylic may be used, such as, for example, one or more of the following: ABS plastic, polycarbonate, glass, thermoformed plastics, and/or other types of materials which may be formed into desired shapes, and which may have desired optical properties, surface finish properties, shape formation properties, etc.

According to different embodiments, the initial peripheral shape of the acrylic sheet (and/or sheets of other types of materials) may be square, round, rectangular, oval and/or other desired shape which is suitable. In at least one embodiment, it is preferred that the dimensions of the acrylic sheet be sufficiently appropriate for enabling the sheet to be formed into a desired shape/size. For example, in one embodiment, a 10′×10′ sheet of acrylic may be used to form a cover as illustrated in FIG. 1 having up to a 7′ diameter (e.g., at base portion 106). In the example of FIGS. 2A-2D, however, a round, flat clear acrylic sheet has been selected to be used to form the conical-shaped cover device 100 as illustrated in FIG. 1.

In at least one embodiment, the process of manufacturing or forming the flat acrylic sheet into a conical-shaped, bonus wheel device cover device (100 in FIGS. 1 and 250 in FIG. 2) may include one or more of the following operations (or combinations thereof), which are not necessarily listed in sequential order. Briefly, in accordance the present invention, the manufacturing method includes substantially supporting a substantially planar, substantially transparent, thermally deformable sheet material 202 about a peripheral base portion 202a of the conical-shaped cover device to be formed. As shown FIG. 2A, the peripheral base portion 202a substantially surrounds or encloses an interior region 202b of the sheet material 202 thereof. The method further includes heating at least the interior region 202b of the sheet material 202 to a deformable condition, and urging at least one of a central portion 202c of the interior region 202b and the base portion 202a of the conical shaped device in a direction opposite one another, and generally along a longitudinal axis of the conical-shaped cover device 250. This opposed relative movement between the central portion 202c and the base portion 202a is performed such that a non-contacted, conical-shaped, intermediate portion 202d (FIGS. 2B and 2C) of the conical shaped cover, between the central portion 202c and the base portion 202a, is formed in a manner that substantially preserves the set of high quality optical properties and/or surface finish properties as that of the original sheet material.

More particularly, an oven may be heated to a desired temperature that is in a lower range of temperatures at the melting point of the selected thermally deformable materials. For instance, for an acrylic sheet material, 0.25 inch in thickness, it may be desirable to heat the acrylic material to a temperature with the range of 290-320° F. (142-160° C.). Other desired temperature ranges for different materials and/or thicknesses may be determined by one having ordinary skill in the art.

In another specific embodiment, the base portion 202a of the sheet material 202 is substantially supported, as shown in FIG. 2A, by an upper and lower clamp member (e.g., 204a, 204b, FIG. 2A) which functions to stabilize the base portion during formation of the conical shaped intermediate portion 202d. In one embodiment, these ring-shaped clamp members are clamped onto the acrylic material (e.g., 202), as shown, on an upper side thereof and a lower side thereof. In one embodiment, only a ringed portion of the acrylic material makes contact with the upper and lower clamp members 204a, 204b, leaving the interior region 202b of the acrylic material 202 out of contact with any of the manufacturing tooling at this phase of the process.

In at least one embodiment, the composition of the clamp members 204a, 204b may include one or more of the following (or combinations thereof): metal, wood, fiberglass, and/or any other suitable material generally known to one having ordinary skill in the art. In one embodiment, the clamping of the acrylic sheet may take place before it is placed into the oven. In a different embodiment, the clamping of the acrylic sheet may take place after it has been placed into the oven.

Referring now to FIGS. 2B and 2C, once the acrylic material 202 has been heated to a desired temperature, a deforming tool 209 may be used to deform the shape of the acrylic material into a desired conical shape. As illustrated in the example embodiments of FIGS. 2B and 2C, the deforming tool 209 may include a head portion 210 and a shaft portion 211. In at least one embodiment, the head portion 210 of the deforming tool makes contact with a center region (e.g., central portion 202c) of the interior region 202b, urging the central portion 202c away from the stabilized base portion 202a. As shown in FIGS. 2B and 2C, by slowly displacing the tool head portion 210 relative to the clamp members 204, the shape of the acrylic material is caused to conically deform.

In accordance with the present invention, the deforming tool 210 does not make contact any portion of acrylic material in tapered or conical-shaped intermediate region 202d during deformation. As a result, there is no degradation of optical properties and/or surface finish properties of the tapered region of acrylic material 202b. This result is far superior to the formation of the current dome-shaped cover devices since contact of the dome-shaped portions during molding require “secondary processing” in order to attain the original high quality optical and surface finish properties of the original sheet material.

Once the acrylic material has been deformed (or formed) into the desired shape, the acrylic material is allowed to cool, and the deforming tool 209 is removed. In one embodiment, the deforming tool may be used to provide structural support to the acrylic material 202 during the cooling process, in order to help the acrylic material to retain the desired shape until it has sufficiently cooled. In other embodiments, the deforming tool may be removed (e.g., may be disengaged from contacting the acrylic material) before the acrylic material is cooled.

FIG. 2D best illustrates an example of a conical-shaped cover device 250 which has been formed using the manufacturing/shaping process described in FIGS. 2A-2C. In at least one embodiment, the conical-shaped intermediate portion 252 of the shaped acrylic material 250 (FIG. 2D) may have optical properties (e.g., haze, visible transmission, etc.) which are substantially similar to (or better than) the optical properties of the original acrylic material portion 202 of FIG. 2A (e.g., which corresponds to the state of the acrylic material as it existed before the shape formation process was performed). Thus, for example, if the acrylic material portion 202b of FIG. 2A were to have optical properties (before shape processing) of 3% haze and 90% visible transmission, portion 252 of FIG. 2D may also have optical properties which meet or exceed 3% haze and 90% visible transmission. Similarly, in at least one embodiment, the conical-shaped portion 252 of the shaped acrylic material 250 (FIG. 2D) may have surface finish properties which are substantially similar to (or better than) the surface finish properties of the interior region 202b of FIG. 2A (e.g., which corresponds to the state of the acrylic material 202 as it existed before the shape formation process was performed).

After the conical-shaped cover device 250 has been allowed to sufficiently cool (e.g., to room temperature and/or to a temperature which no longer enables the shape of the acrylic material to be permanently altered), the conical-shaped cover device 250 may undergo additional processing such, as, for example, routing, drilling, cutting, buffing, etc. However, in at least one embodiment, there is no need to perform any additional secondary processing on conical intermediate portion 252 of the cover device 250 in order to improve the optical quality and/or surface finish quality of the inner and/or outer surfaces of the intermediate portion 252.

FIGS. 2B and 2C illustrate different embodiments of manufacturing/shape formation processes which may be used, for example, to manufacture a cover such as that illustrated in FIG. 1. More specifically, FIG. 2B illustrates one embodiment of a convex shape manufacturing process, and FIG. 2C illustrate one embodiment of a concave shape manufacturing process.

As illustrated in the example of FIG. 2B, the material to be shaped (e.g., acrylic material in this example) is held and/or supported by ringed clamping members 204a, 204b. In at least one embodiment, the material of the clamp members 204a, 204b may include one or more of the following (or combinations thereof): metal, wood, fiberglass, and/or any other suitable material generally known to one having ordinary skill in the art. The width (W) of the at least one of the ringed clamping members may range, for example, from about 1-6 inches. In one embodiment, width (W) of the at least one of the ringed clamping members may be about 3 inches.

In one specific embodiment, the head portion 210 of the deforming tool 209 may include a substantially flat, and/or substantially circular surface portion which makes contact with interior region 202b during formation, resulting in an substantially flat central portion 202c. In other embodiments, the shape, size and/or other dimensions associated with the head of the deforming tool may differ according to desire design preferences. For example, according to various embodiments, the shape of the head portion 210 of the deforming tool 209 may be ring shaped, circular, round, spherical, semi-spherical, cylindrical, triangular, square, rectangular, star-shaped, hexagonal, etc. As will be appreciated by one having ordinary skill in the art, the selected size and shape of the deforming tool head (e.g., which makes contact with the material to be deformed) may affect resulting the shape of the formed material.

Referring back to the example of FIG. 2B, the head 210 of the deforming tool may be moved upward (as shown by directional arrow A) to exert an upward pressure on contacted central portion 202c of the interior region 202b. As the head portion 210 is displaced, generally along the direction of the longitudinal axis (although it may be slightly skewed from the axis) a “tenting” or “draping” effect commences whereby intermediate portion 202d is formed into a conical shape. Additionally, as illustrated in the example embodiment of FIG. 2B, the central portion 202c is formed into a substantially flat, circular shape.

In at least one embodiment, the base portion 202a of the material sheet 202 to be shaped may be held relatively stationary by ringed clamping members 204a, 204b, while the deforming tool 209 is moved upward (as shown by directional arrow A) to exert an upward pressure on material portion 202c. In an alternate embodiment, the deforming tool 209 may be substantially stationary, while the base portion 202a is caused to move downward (e.g., via downward movement of the ringed clamping members 204a, 204b), thereby causing an upward pressure to be exerted on material portion 202c. Still further, the deforming tool 209 and the claming members 204 may both be caused to displace relative one another to effectuate the same relative motion therebetween.

According to different embodiments, the location of the region of contact between the deforming head portion 210 and the central portion 202c may affect the resulting the shape of the formed material. Additionally, the angle or vector of movement of the deforming tool may also affect the resulting the shape of the formed material. As illustrated in the example embodiment of FIG. 2B, the head 210 of the deforming tool contact the central region 202c, which corresponds to a circular region located at a substantially center portion of the circular interior region 202b defined by ringed clamping members 204a, 204b. In addition, as shown in the example embodiment of FIG. 2B, the movement of the deforming tool 209 is substantially parallel with the longitudinal axis defined by ringed clamping members 204a, 204b.

Turning back to the manufacturing process embodiment of FIG. 2C, the head portion 210 of the deforming tool may be moved downward (as shown by directional arrow B) to exert a downward pressure on material portion 202c, thereby causing a “tenting” or “draping” effect whereby interior region 202b is formed into a conical shape. In at least one embodiment, the material to be shaped may be held relatively stationary by ringed clamping members 204a, 204b, while the deforming tool 209 is moved downward (as shown by directional arrow B) to exert a downward pressure on central portion 202c. In one embodiment, the deforming tool 209 may be implemented as a weighted object having a desired shape, size and weight (e.g., a 30-90 lb. object having a substantially circular surface portion), relying on the gravitational force to displace and move the head portion 210 in a downward direction. In an alternate embodiment, the deforming tool may be stationary, and the material may be moved upward (e.g., via upward movement of the ringed clamping members 204a, 204b) to thereby cause a downward pressure to be exerted on material portion 202c.

The desired rate of deformation of the material, and desired pressure exerted by the deforming tool may be selected such that the following conditions are satisfied: 1) the material being deformed is not cracked or otherwise structurally damaged during deformation process; and/or 2) the conical-shaped or tapered intermediate portion(s) (e.g., 252, FIG. 2D) being deformed is/are prevented from draping or sagging no more than 0.5 inches per 3 linear feet of material.

In at least one embodiment, the desired rate of deformation of the material, and desired pressure exerted by the deforming tool may be dependent on a variety of factors which, for example, may include, but are not limited to, one or more of the following (or combinations thereof): material type/composition, material size, material thickness, material temperature, duration of process, etc.

For instance, in one embodiment, when the sheet of material reaches a desired deformable temperature range, the deforming tool 209 may begin to apply the pressure on interior region 202c in order to begin deforming the material as illustrated, for example, in FIG. 2B. During the shape formation process, the surface and/or edges of conical intermediate portion 202d of the interior region 202b may be visually inspected in order to detect excessive sagging or draping of the sheet material 202 (e.g., regions where there is greater than 0.5 inches of sag per 3 continuous feet of material). If excessive sag or draping is detected, it may be due to the fact that the deforming tool 209 is displacing too slowly.

Accordingly, in one embodiment, the rate of movement of the deforming tool (and/or pressure exerted by the deforming tool) may be increased in response to detecting excess draping or sagging of the material beyond the permitted sag rate. In at least one embodiment, increasing the rate of movement of the deforming tool 209 (and/or pressure exerted by the deforming tool) may result in a reduction in the amount of excessive sag or drape of the material (e.g., similar to the effect of pulling on a portion of a sagging string to reduce the amount of sag in the string). However, care should be taken not to increase the rate of movement of the deforming tool (and/or pressure exerted by the deforming tool) to a level which may induce cracking and/or other irreparable structural damage in the material being deformed. In one specific example, the material may be slowly deformed over a substantial length of time (e.g., 4-12 hours) in order to achieve its final, desired shape/form, as well as maintain its desired optical and surface finish properties.

In accordance with the present invention, and as illustrated in the example embodiments of FIGS. 2B and 2C, the deforming tool 209 does not make contact with any of the intermediate portion 202d of the interior region 202b. As a result, as indicated, there is no degradation of optical properties and/or surface finish properties of the tapered intermediate region 202d of in conical-shaped cover. Accordingly, in at least one embodiment, the tapered intermediate portion 202d of the sheet material 202 may be formed in a manner which preserves the optical properties and/or surface finish properties of that region of the formed product.

Further, as illustrated in FIG. 2D, the resulting product of the shape formation process includes a conical-shaped portion 252 of the shaped acrylic material 250 which has optical properties and surface finish properties that are substantially similar to the optical properties and surface finish properties of the original acrylic sheet which was used to form shaped item 250. Thus, in at least one embodiment, there is no need to perform any additional secondary processing on portion 252 of the product 250 in order to improve the optical quality and/or surface finish quality of the inner and/or outer surfaces of portion 252. This in turn results in a cost savings of two to three times, as compared, for example, to conventional dome manufacturing techniques.

The results are a conical-shaped cover device that may be manufactured inexpensively to scale while achieving a very high level of optical clarity. This also provides an advantage of enabling an optically clear part to be created directly from the molding process.

It will be appreciated that one of the factors which led to the inventive manufacturing techniques described herein relates to the novel idea of changing the bonus wheel device design concept from a spherical approach to a conical one. This, in turn, helped to foster ideas of only having to touch the piece of acrylic in two areas to make the cone shape. In at least one embodiment, these two areas are the outer ring or base portion 106, 202a (e.g., ringed flange portion 106a, FIG. 1) and the inner central portion (e.g., 104 in FIG. 1, and 202c in FIG. 2).

Referring back to FIG. 2D, in at least one embodiment, flange portions 253 of the shaped item 250 may correspond to regions which were contacted by clamping members 204a, 204b. Additionally, at least a portion of central portion 254 if the shaped item 250 may correspond to a region which was contacted by the deforming tool.

According to various embodiments described herein, a bonus wheel device cover may be manufactured from a given material in a way such that the thermal forming tools used do not touch any of the “visual areas” of the cover. In one embodiment, the “visual areas” of the cover correspond to those areas of the cover which may be visible to casino patrons after the cover has been installed over the bonus wheel device. In other embodiments, the “visual areas” of the cover correspond to those areas of the cover which are used (or which are intended to be used) to cover the visible portions of the bonus wheel device (i.e., intermediate portion 252).

For example, FIG. 7 shows an example of a Wheel of Fortune® Special Edition™ Super Spin multi-player gaming station 700 which includes a large, central bonus wheel device 704. In at least one embodiment, a cover device 701 similar to that illustrated in FIG. 1 (e.g., formed using one of the manufacturing processes described herein) may be installed over the bonus wheel device 704. In such an embodiment, conical-shaped intermediate portion 702 of the cover device 701 may correspond to the “visual areas” of the cover which is to be positioned over the visible portions of the bonus wheel device 704.

In at least one embodiment, referring back to FIG. 1, when the cover device 100 is installed over a bonus wheel device, flange portions 106a of the base portion 106 may be hidden from view of the casino patrons, and may be used as part of the mounting mechanism of the cover. Additionally in at least one embodiment, central portion 104 of cover device 100 may be hidden from view of the casino patrons, and used as a mounting mechanism or support mechanism for mounting various types of signage thereto.

FIGS. 6A-6C illustrate examples of a Wheel of Fortune® Mini-Super-Spin multi-player gaming station 600 which includes a large, central bonus wheel device 602. In the examples of FIGS. 6A-6C, only about 200 degrees of the bonus wheel device is visible to the players at any given time. Accordingly, in at least one embodiment where it is desirable to cover only the visible portion of the bonus wheel device, a conical shaped cover similar to that illustrated in FIG. 1 may manufactured using one of the manufacturing processes described herein (e.g., initially formed as a 360 degree piece), and then trimmed to the desired final shape to be mounted over the visible portion of the bonus wheel device as illustrated, for example, in FIGS. 6A-6C.

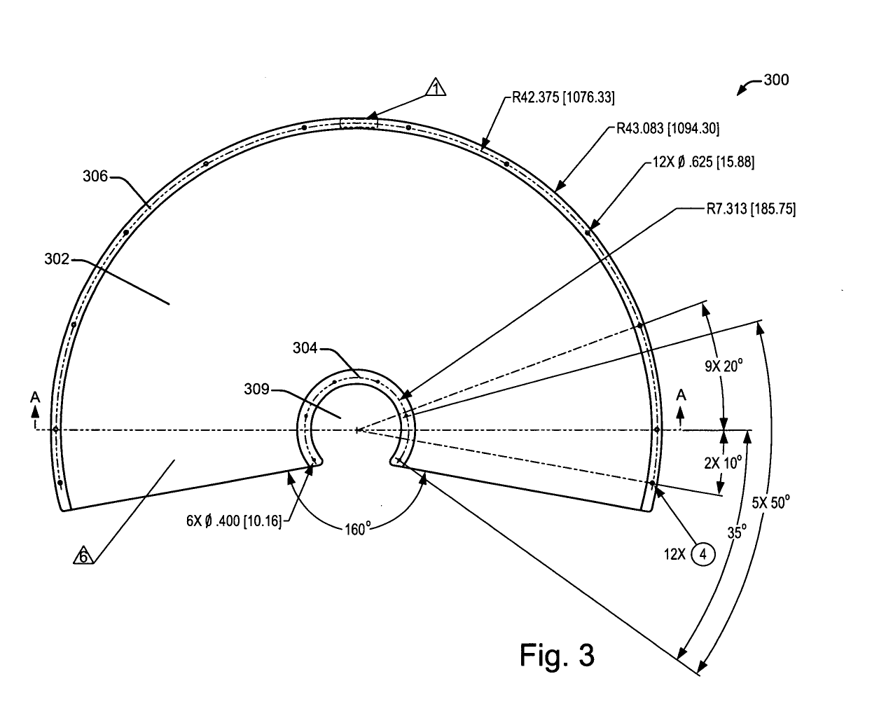

FIGS. 3-5 illustrate various design details relating to a specific embodiment of a conical cover which, for example, may be used as a bonus wheel device cover for the Wheel of Fortune® Mini-Super-Spin multi-player gaming station of FIGS. 6A-6C.

For example, FIG. 3 shows a top plan view of a specific embodiment of bonus wheel device cover portion 300 which may be formed using at least one of the manufacturing techniques described herein. In at least one embodiment, cover portion 300 may be initially formed as a 360 degree piece (e.g., similar to that illustrated in FIG. 1), and then trimmed to a desired final shape in accordance with the specifications provided in FIGS. 3-5, for example.

As illustrated in the example of FIG. 3, cover portion 300 may include outer ringed portion 306, inner ringed portion 304, and intermediate conical portion 302 which may correspond to the “visual areas” of the cover that is to be positioned over the visible portion of the bonus wheel device 602.

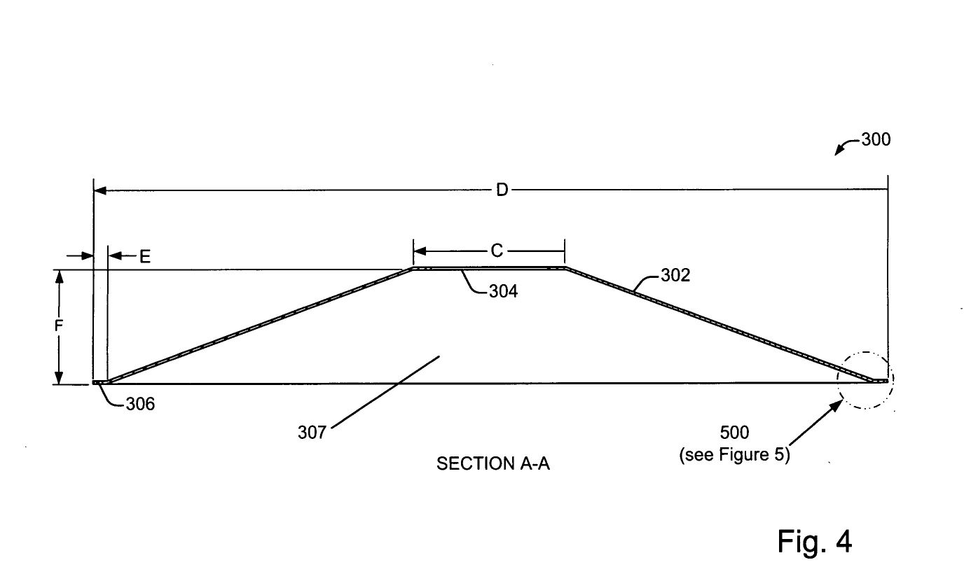

FIG. 4 shows a cross sectional view of the bonus wheel device cover portion 300, taken along the plane of the lines A-A of FIG. 3.

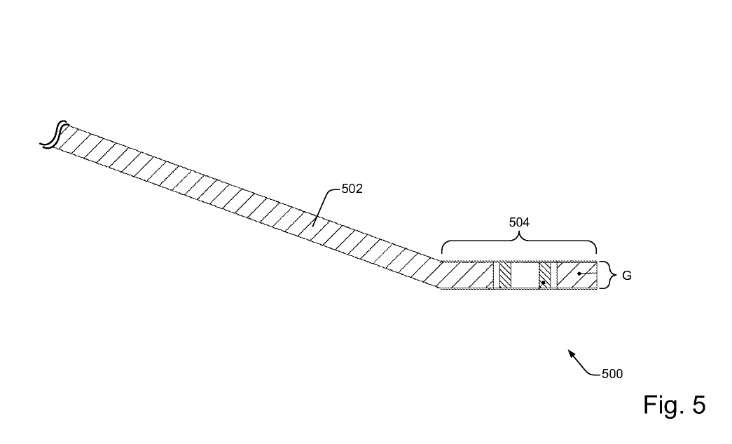

FIG. 5 shows a detailed view of region 500 of FIG. 4.

According to specific embodiments, the dimensional variables C-G shown in FIGS. 4-5 may have corresponding values within the following ranges:

C=about 4 in. to 15 ft., and more preferably about 1 ft to 3 ft.

D=about 1 ft to 30 ft., and more preferably about 4 ft to 15 ft.

E=about 1 in. to 5 ft., more preferably about 4 in. to 1 ft.

F=about 6 in. to 10 ft., and more preferably about 1 ft. to 5 ft.

G=about 0.032 in. to 2 in., and more preferably about 0.060 in. to 0.375 in.

Further, as illustrated in FIGS. 6A-6C, when the trimmed conical cover portion is installed over the bonus wheel device 602, the flange portions of the trimmed cover may be hidden from view of the casino patrons as shown at 606, and/or may be used as part of the mounting mechanism of the cover. Additionally as illustrated in FIGS. 6A-6C, the flat center portion of the trimmed cover may be hidden from view of the casino patrons, and/or used as a mounting mechanism or support mechanism for mounting various types of signage thereto, as illustrated, for example, at 604.

In at least one embodiment, it is preferable that the covers of the bonus wheel devices be as clear and unobtrusive as possible. However, the cost, appearance, and replacement of such covers may also be taken into account.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

What is claimed:

1. A method for manufacturing a conical-shaped cover device from a substantially planar, substantially transparent, thermally deformable sheet material having a first set of optical and surface finish properties comprising:
substantially supporting the sheet material about a peripheral base portion of the conical-shaped cover device to be formed, said base portion substantially enclosing an interior region thereof;
heating at least the interior region of the sheet material to a deformable condition; and
urging at least one of a central portion of the interior region and the base portion of the conical shaped device in a direction opposite one another, and generally along the longitudinal axis of the conical-shaped cover device such that a non-contacted, conical-shaped, intermediate portion of the conical shaped cover, between the central portion and the base portion, is formed in a manner that substantially preserves the first set of optical properties and/or surface finish properties.

2. The method according to claim 1, wherein
said supporting the sheet material includes substantially preventing displacement of the base portion in a direction along a longitudinal axis of the conical-shaped cover device.

3. The method according to claim 1, wherein
said supporting the sheet material includes clamping the base portion of the conical-shaped cover device between an upper surface of the sheet material and an opposed lower surface of the sheet material.

4. The method according to claim 3, wherein
said clamping is performed by upper and lower opposed clamping members contacting the upper surface and the opposed lower surface the sheet material.

5. The method according to claim 4, wherein
each clamping member is ring-shaped.

6. The method according to claim 1, wherein
said heating at least the interior region of the sheet material includes heating the sheet material to a temperature range at a lower region of the sheet material melting point.

7. The method according to claim 1, wherein
said urging at least one of a central portion of the interior region and the base portion includes contacting the interior region central portion with a plunger head pushing the central portion in said direction along the longitudinal axis and away from said base portion.

8. The method according to claim 8, wherein
said base portion is substantially circular, and
said plunger head is substantially circular, having a diameter substantially smaller than that of the base portion.

9. A conical-shaped cover device manufactured by the process of claim 1.
